(19) United States
(12) Patent Application Publication
(10) Pub. No.: US 2023/0169362 A1
(43) Pub. Date: Jun. 1, 2023

(54) SHARED NETWORK LEARNING FOR MACHINE LEARNING ENABLED TEXT CLASSIFICATION

(71) Applicant: SAP France, Levallois-Perret (FR)

(72) Inventor: Thomas Beucher, Nice (FR)

(21) Appl. No.: 17/538,120

(22) Filed: Nov. 30, 2021

(51) Int. Cl. G06N 5/04; G06N 20/00

(52) U.S. Cl. CPC G06N 5/04; G06N 20/00

(57) ABSTRACT

A method may include training a first machine learning model to perform a question generation task and a second machine learning model to perform a question answering task. The first machine learning model and the second machine learning model may be subj ected to a collaborative training in which a first plurality of weights applied by the first machine learning model generating one or more questions are adjusted to minimize an error in an output of the second machine learning model answering the one or more questions. The first machine learning model and the second machine learning model may be deployed to perform a natural language processing task that requires the first machine learning model to generate a question and/or the second machine learning model to answer a question. Related methods and articles of manufacture are also disclosed.

### FIELD

The present disclosure generally relates to machine learning and more specifically to shared network learning for machine learning enabled text classification.

### BACKGROUND

Machine learning models may be trained to perform a variety of cognitive tasks. For example, a machine learning model trained to perform natural language processing may classify text by at least assigning, to the text, one or more labels indicating a sentiment, a topic, and/or an intent associated with the text. Training the machine learning model to perform natural language processing may include adjusting the machine learning model to minimize the errors present in the output of the machine learning model. For instance, training the machine learning model may include adjusting the weights applied by the machine learning model in order to minimize a quantity of incorrect labels assigned by the machine learning model.

### SUMMARY

Methods, systems, and articles of manufacture, including computer program products, are provided for shared network learning. In one aspect, there is provided a system. The system may include at least one data processor and at least one memory. The at least one memory may store instructions that result in operations when executed by the at least one data processor. The operations may include: generating a first training set to include a first training data associated with a first machine learning model performing a first text classification task and a second training data associated with a second machine learning model performing a second text classification task, the first training data including a first plurality of expressions that are different than a second plurality of expressions comprising the second training data; training, based at least on the first training set, a shared machine learning model to perform a text embedding task; and deploying the trained shared machine learning model to generate a text representation of an expression that enables the first machine learning model and/or the second machine learning model to correctly determine an intent of the expression.

In some variations, one or more of the features disclosed herein including the following features can optionally be included in any feasible combination. In some variations, the training of the shared machine learning model may further include adjusting the one or more weights applied by the shared machine learning model such that the shared machine learning model generates, for a second expression from the second training data, a second text representation that enables the second machine learning model to correctly determine a second intent of the second expression.

In some variations, the operations may further include: generating a second training set to include a third training data associated with a third machine learning model performing a third text classification task; and training the shared machine learning model by at least subjecting the shared machine learning model to a first training iteration using the first training set and a second training iteration using the second training set.

In some variations, the operations may further include: tuning one or more of the shared machine learning model, the first machine learning model, or the second machine learning model on the first training data and/or the second training data by applying a regularization technique.

In some variations, the first text classification task and the second classification task comprise natural language processing (NLP) applications associated with different industries.

In some variations, the shared machine learning model may perform the text embedding task by applying one or more of sum, average, power mean (p-mean), word piece model, skip-thoughts-vectors, quick-thoughts-vectors, InferSent, multi-tasks learning, or Google universal sentence encoder.

In some variations, the shared machine learning model may include a recurrent neural network (RNN), a convolutional neural network (CNN), and/or a transformer.

In some variations, the first machine learning model and/or the second machine learning model may include one or more of a multilayer perceptron (MLP), a recurrent neural network (RNN), a convolutional neural network (CNN), or a transformer.

In some variations, the first machine learning model and/or the second machine learning model may determine the intent of the expression by at least assigning, to the expression, one or more labels corresponding to an intent of the expression.

In another aspect, there is provided a method for shared network learning. The method may include: generating a first training set to include a first training data associated with a first machine learning model performing a first text classification task and a second training data associated with a second machine learning model performing a second text classification task, the first training data including a first plurality of expressions that are different than a second plurality of expressions comprising the second training data; training, based at least on the first training set, a shared machine learning model to perform a text embedding task; and deploying the trained shared machine learning model to generate a text representation of an expression that enables the first machine learning model and/or the second machine learning model to correctly determine an intent of the expression.

In some variations, one or more of the features disclosed herein including the following features can optionally be included in any feasible combination. The training of the shared machine learning model may include adjusting one or more weights applied by the shared machine learning model such that the shared machine learning model generates, for a first expression from the first training data, a first text representation that enables the first machine learning model to correctly determine a first intent of the first expression.

In some variations, the training of the shared machine learning model may further include adjusting the one or more weights applied by the shared machine learning model such that the shared machine learning model generates, for a second expression from the second training data, a second text representation that enables the second machine learning model to correctly determine a second intent of the second expression.

In some variations, the method may further include: generating a second training set to include a third training data associated with a third machine learning model performing a third text classification task; and training the shared machine learning model by at least subjecting the shared machine learning model to a first training iteration using the first training set and a second training iteration using the second training set.

In some variations, the method may further include: tuning one or more of the shared machine learning model, the first machine learning model, or the second machine learning model on the first training data and/or the second training data by applying a regularization technique.

In some variations, the first text classification task and the second classification task comprise natural language processing (NLP) applications associated with different industries.

In some variations, the shared machine learning model may perform the text embedding task by applying one or more of sum, average, power mean (p-mean), word piece model, skip-thoughts-vectors, quick-thoughts-vectors, InferSent, multi-tasks learning, or Google universal sentence encoder.

In some variations, the shared machine learning model may include a recurrent neural network (RNN), a convolutional neural network (CNN), and/or a transformer.

In some variations, the first machine learning model and/or the second machine learning model may include one or more of a multilayer perceptron (MLP), a recurrent neural network (RNN), a convolutional neural network (CNN), or a transformer.

In another aspect, there is provided a computer program product that includes a non-transitory computer readable storage medium. The non-transitory computer-readable storage medium may include program code that causes operations when executed by at least one data processor. The operations may include: generating a first training set to include a first training data associated with a first machine learning model performing a first text classification task and a second training data associated with a second machine learning model performing a second text classification task, the first training data including a first plurality of expressions that are different than a second plurality of expressions comprising the second training data; training, based at least on the first training set, a shared machine learning model to perform a text embedding task; and deploying the trained shared machine learning model to generate a text representation of an expression that enables the first machine learning model and/or the second machine learning model to correctly determine an intent of the expression.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to machine learning enabled text classification, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a network diagram illustrating a shared network learning system, in accordance with some example embodiments;

FIG. 2A depicts a schematic diagram illustrating an architecture for an example of a shared network learning system, in accordance with some example embodiments;

FIG. 2B depicts a schematic diagram illustrating an example of a shared network learning system, in accordance with some example embodiments;

FIG. 3 depicts a table illustrating the performance of an efficient sparse logistic regression (ESLR) model and a shared machine learning model, in accordance with some example embodiments;

FIG. 4 depicts a flowchart illustrating an example of a process for shared network learning, in accordance with some example embodiments; and

FIG. 5 depicts a block diagram illustrating an example of a computing system, in accordance with some example embodiments.

When practical, like labels are used to refer to same or similar items in the drawings.

### DETAILED DESCRIPTION

Some natural language processing tasks, such as text classification, may require the deployment of multiple machine learning models. For example, a first machine learning model may be trained to generate a representation of text (e.g., word embedding, sentence embedding, and/or the like) such that a second machine learning may classify the text based on the representation of the text. The first machine learning model and the second machine learning model may be trained to perform their respective natural language processing tasks through supervised learning. However, training the first machine learning model and the second machine learning model for optimal performance may require a large corpus of labeled training samples. Moreover, the performance of the second machine learning model in correctly classifying text may be contingent upon the performance of the first machine learning model in generating a representation that captures the context of each word (or token) present in the text. Thus, if a limited quantity of training samples is available for the second machine learning model, which may be the case if the second machine learning model is associated with a niche application, neither the first machine learning model nor the second machine learning model may be trained to achieve optimal performance.

In some example embodiments, a first machine learning model may be trained to perform a text embedding task based on a first training data associated with a second machine learning model performing a first text classification task and a second training data associated with a third machine learning model performing a second text classification task. The first classification task may be different from the second text classification task at least because the second machine learning model and the third machine learning model are deployed for applications in different industries such as telecommunication, insurance, food service, healthcare, and transportation. Accordingly, the first training data and the second training data may include different expressions and different ground truth labels of the corresponding intent. Moreover, the first machine learning model may be trained to generate representations of the expressions included in the first training data and the second training data that maximize the respective performance of the second machine learning model and the third machine learning model.

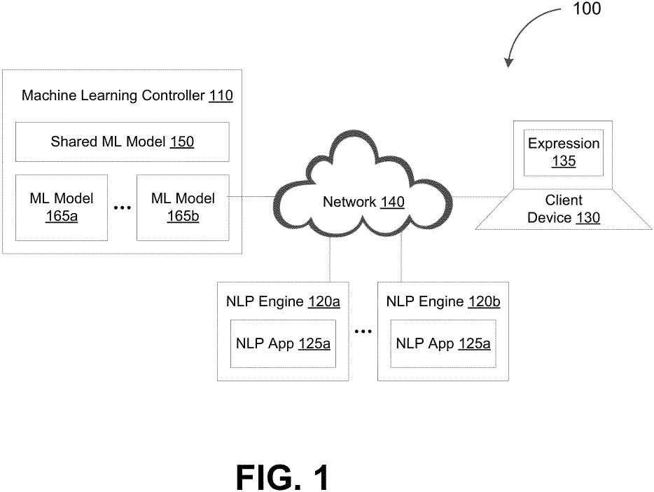

FIG. 1 depicts a system diagram illustrating an example of a shared network learning system 100, in accordance with some example embodiments. Referring to FIG. 1, the shared network learning system 100 may include a machine learning controller 110, one or more natural language processing engines 120, and a client device 130. The machine learning controller 110, the one or more natural language processing engines 120, and the client device 130 may be communicatively coupled via a network 140. It should be appreciated that the client device 130 may be a processor-based device including, for example, a smartphone, a tablet computer, a wearable apparatus, a virtual assistant, an Internet-of-Things (IoT) appliance, and/or the like. The network 140 may be a wired network and/or a wireless network including, for example, a wide area network (WAN), a local area network (LAN), a virtual local area network (VLAN), a public land mobile network (PLMN), the Internet, and/or the like.

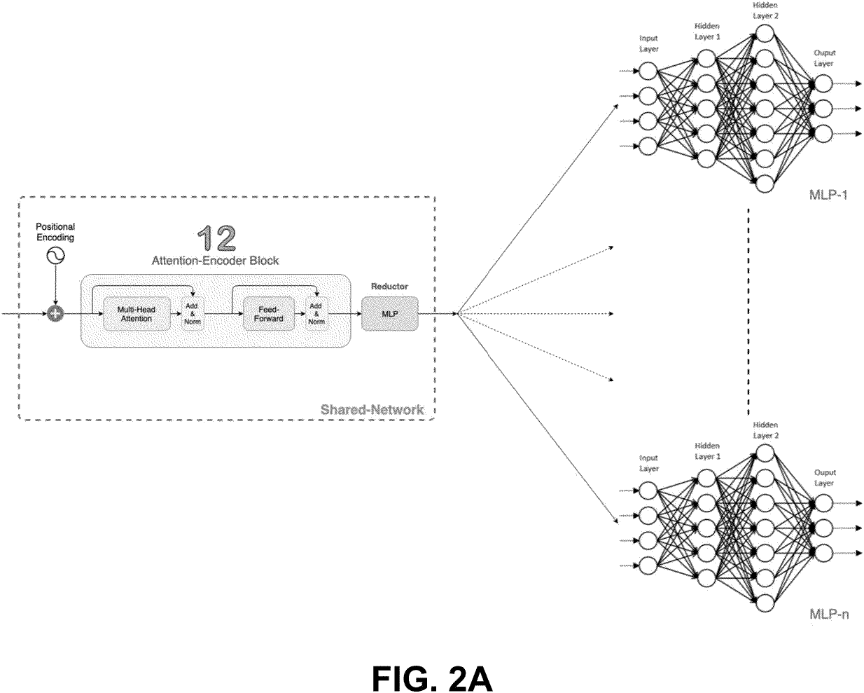

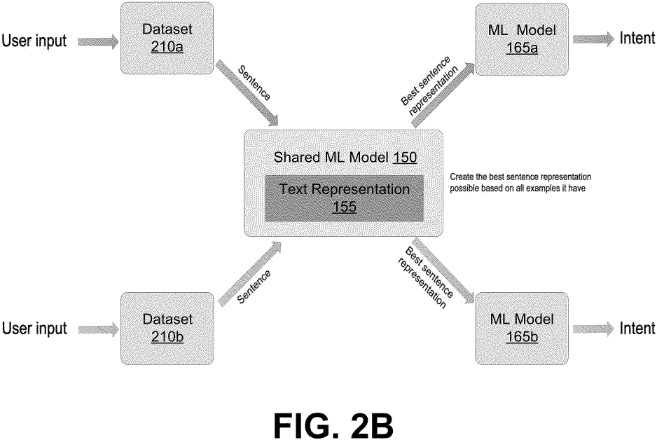

Referring again to FIG. 1, the machine learning controller 110 may include a shared machine learning model 150 trained to perform a text embedding task including, for example, word embedding, contextual word embedding, byte pair encoding (BPE), sentence embedding, and/or the like. The shared machine learning model 150 may apply a variety of text embedding techniques including, for example, sum, average, power mean (p-mean), word piece model, skip-thoughts-vectors, quick-thoughts-vectors, InferSent, multi-tasks learning, Google universal sentence encoder, and/or the like. Moreover, the shared machine learning model 150 may include one or more of a recurrent neural network (with or without an attention mechanism), a convolutional neural network, or a transformer. Furthermore, as shown in FIG. 1, the machine learning controller 110 may include a first machine learning model 165a and a second machine learning model 165b, each of which being trained to perform a different text classification task. The first machine learning model 165a and the second machine learning model 165b may each include, for example, one or more of a multilayer perceptron (MLP), a recurrent neural network (RNN), a convolutional neural network (CNN), a transformer, and/or the like. To further illustrate, FIG. 2A depicts a schematic diagram illustrating the architecture of an example of the shared network learning system 100 in which the shared machine learning model 150 is a transformer encoder network (e.g., a bidirectional encoder representations from transformers (BERT) model and/or the like) while the first machine learning model 165a and the second machine learning model 165b are multilayer perceptrons.

In the example shown in FIG. 1, the first machine learning model 165a may be deployed to a first natural language processing engine 120a to support a first natural language processing application 125a while the second machine learning model 165b may be deployed to a second natural language processing engine 120b to support a second natural language processing application 125b. The first natural language processing application 125a and the second natural language processing application 125b may cater to different industries (e.g., telecommunication, insurance, food service, healthcare, transportation, and/or the like). For instance, the first natural language processing application 125a and the second natural language processing application 125b may be chatbots that cater to different industries. As such, the first machine learning model 165a may encounter different expressions than the second machine learning model 165b. Moreover, the first machine learning model 165a may be trained to recognize different intent than the second machine learning model 165b.

The first machine learning model 165a and the second machine learning model 165b may perform their respective text classification tasks based on the text representations (e.g., word embeddings, sentence embeddings, and/or the like) generated by the shared machine learning model 150. For example, the first machine learning model 165a and the second machine learning model 165b may perform their respective text classification tasks by at least assigning, based on the text representation of an expression generated by the shared machine learning model 150, one or more labels to the expression that correspond to an intent of the expression. The performance of the first machine learning model 165a and the second machine learning model 165b in performing their respective text classification tasks may therefore be contingent upon the performance of the shared machine learning model 150 in generating text representations.

Accordingly, in some example embodiments, the shared machine learning model 150 may be trained using training data associated with multiple machine learning models, each of which being trained to perform a different text classification task. For example, the machine learning controller 110 may be generate a training set for training the shared machine learning model 150 that includes training data associated with multiple machine learning models. In some instances, the machine learning controller 110 may generate, for each training iteration that the shared machine learning model 150 is subjected to, a training set with expressions associated different machine learning models. For instance, the machine learning controller 110 may generate a first training set for a first training iteration and a second training set for a second training iteration. The first training set may include expressions associated with a first set of machine learning models while the second training set may include expressions associated with a second set of machine learning models. As such, the training of the shared machine learning model 150 may include exposing the shared machine learning model 150 to expressions associated with a variety machine learning models, thus avoiding the shared machine learning model 150 from being overfitted to the expressions associated with any particular machine learning model.

To further illustrate, FIG. 2B shows that the shared machine learning model 150 may be trained to generate, for example, for an expression 135 received from the client device 130, a text representation 155 that enables the first machine learning model 165a and/or the second machine learning model 165b to generate a label correctly classifying the intent of the expression 135. Furthermore, FIG. 2B shows that the shared machine learning model 150 may be trained using at least a portion of a first dataset 210a associated with the first machine learning model 165a and at least a portion of a second dataset 210b associated with the second machine learning model 165b. In doing so, the performance of the shared machine learning model 150 may be optimized by the shared machine learning model 150 learning to generate text representations of expressions associated with different text classification tasks. In some instances, the machine learning controller 110 may reserve at least a portion of the first dataset 210a and/or the second dataset 210b as testing data to evaluate the respective performance of the shared machine learning model 150, the first machine learning model 165a, and the second machine learning model 165b. Moreover, one or more of the shared machine learning model 150, the first machine learning model 165a, and the second machine learning model 165b may be fine-tuned on each of the first dataset 210a and the second dataset 210b by applying a regularization technique such as label smoothing.

In some example embodiments, the training of the shared machine learning model 150 may include adjusting the shared machine learning model 150, including one or more of the weights applied by the shared machine learning model 150, to minimize an error in the outputs of the first machine learning model 165a and the second machine learning model 165b. For example, for a first expression from the first training data associated with the first machine learning model 165a, the machine learning controller 110 may train the shared machine learning model 150 by adjusting, through backpropagation of the error present in the output of the first machine learning model 165a, one or more of the weights applied by the shared machine learning model 150 such that the label assigned to the first expression by the first machine learning model 165a based on a first text representation generated by the shared machine learning model 150 matches the ground truth label associated with the first expression. Furthermore, the machine learning controller 110 may adjust one or more of the weights applied by the shared machine learning model 150 such that the shared machine learning model 150 generates, for a second expression from the second training data associated with the second machine learning model 165b, a second text representation that enables the second machine learning model 165b to correctly classify the second expression.

Table 1 below includes pseudo programming code that implements an algorithm for training a shared network (e.g., the shared machine learning model 150) and an n quantity of classifiers (e.g., the first machine learning model 165a, the second machine learning model 165b, and/or the like).

TABLE 1

Algorithm 1 Training Procedure
Input: batchs of datasets B, number of epochs N
1: for epoch in N do
2: for batch in B do
3: for dataset in batch do
4: Samples n elements (n=64) from dataset
5: Forward pass through the network
6: Compute Loss & Gradients
7: end for
8: Perform optimization step (Backpropagation)
9: end for
10: end for

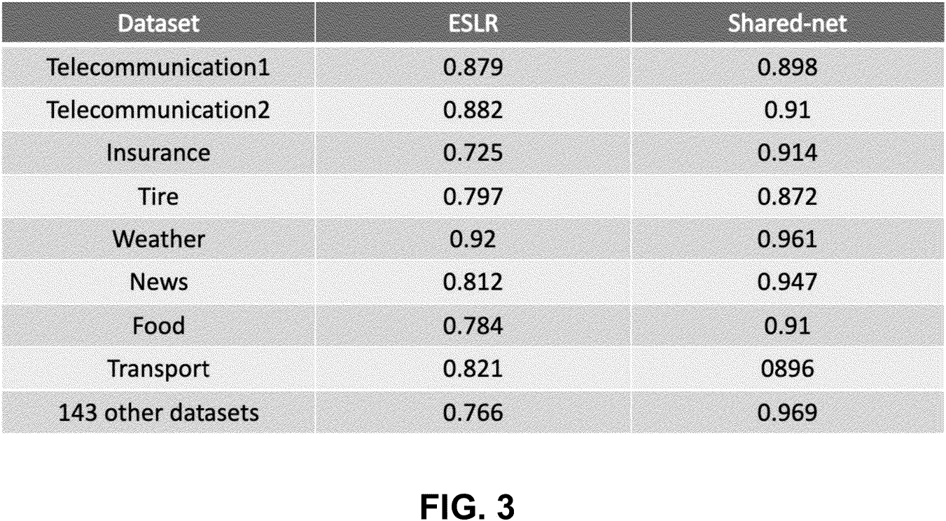

FIG. 3 depicts a table 300 illustrating the performance of a conventional efficient sparse logistic regression (ESLR) model and the shared machine learning model 150 to correctly classify the intent of expressions from a variety of datasets. As shown in FIG. 3, the text representations generated by the shared machine learning model 150, which is trained using training data associated with multiple machine learning models performing different text classification tasks, may increase the subsequent performance of the machine learning models performing text classification based on these text representations.

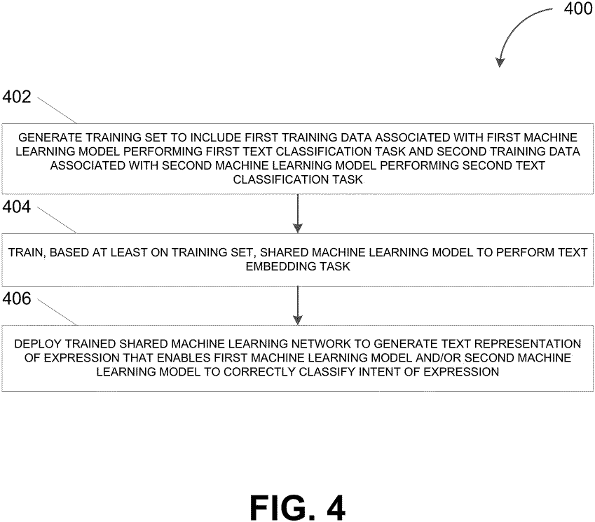

FIG. 4 depicts a flowchart illustrating an example of a process 400 for shared network learning, in accordance with some example embodiments. Referring to FIG. 4, the process 400 may be performed by the machine learning controller 110 to train the shared machine learning model 150 to generate text representations that form the basis of the text classification tasks performed by the first machine learning model 165a and the second machine learning model 165b.

At 402, the machine learning controller 110 may generate a training set that includes a first training data associated with a first machine learning model performing a first text classification task and a second training data associated with a second machine learning model performing a second text classification task. In some example embodiments, the shared machine learning model 150 may be trained using training data associated with multiple machine learning models, each of which being trained to perform a different text classification task. Accordingly, in the example shown in FIG. 1, the machine learning controller 110 may generate a training set that includes at least a portion of the first dataset 210a associated with the first machine learning model 165a and at least a portion of the second dataset 210b associated with the second machine learning model 165b. The first machine learning model 165a and the second machine learning model 165b may perform different text classification tasks such as supporting the first natural language processing application 125a and the second natural language processing application 125b catering to different industries (e.g., telecommunication, insurance, food service, healthcare, transportation, and/or the like). As such, the first dataset 210a and the second dataset 210b may include different expressions and different ground truth labels of the corresponding intent. Training of the shared machine learning model 150 based on a training set that includes expressions from the first dataset 210a and the second dataset 210b may ensure that the shared machine learning model 150 is exposed to expressions associated with the first learning model 165a and the second machine learning model 165b instead of being overfitted to the expressions associated with any particular machine learning model.

At 404, the machine learning controller 110 may train, based at least on the training set, a shared machine learning model to perform a text embedding task. For example, the training of the shared machine learning model 150 may include adjusting one or more of the weights applied by the shared machine learning model 150 such that the shared machine learning model 150 generates, for a first expression from the first dataset 210a associated with the first machine learning model 165a, a first text expression that enables the first machine learning model 165a to correctly classify the first expression. Furthermore, the training of the shared machine learning model 150 may include adjusting one or more of the weights applied by the shared machine learning model 150 such that the shared machine learning model 150 generates, for a second expression from the second dataset 210b associated with the second machine learning model 165b, a second text representation that enables the second machine learning model 165b to correctly classify the second expression.

At 406, the machine learning model controller 110 may deploy the trained shared machine learning model to generate a text representation of an expression that enables the first machine learning model and/or the second machine learning model to correctly determine an intent of the expression. For example, as shown in FIG. 1, the first machine learning model 165a may be deployed to the first natural language processing engine 120a to support the first natural language processing application 125a while the second machine learning model 165b may be deployed to the second natural language processing engine 120b to support the second natural language processing application 125b. The first natural language processing application 125a and the second natural language processing application 125b may cater to different industries (e.g., telecommunication, insurance, food service, healthcare, transportation, and/or the like). Nevertheless, the first machine learning model 165a and the second machine learning model 165b may generate, based at least on the text representations generated by the shared machine learning model 150, a label that correctly classifies the different expressions encountered at each of the first machine learning model 165a and the second machine learning model 165b.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: generating a first training set to include a first training data associated with a first machine learning model performing a first text classification task and a second training data associated with a second machine learning model performing a second text classification task, the first training data including a first plurality of expressions that are different than a second plurality of expressions comprising the second training data; training, based at least on the first training set, a shared machine learning model to perform a text embedding task; and deploying the trained shared machine learning model to generate a text representation of an expression that enables the first machine learning model and/or the second machine learning model to correctly determine an intent of the expression.

Example 2: The system of example 1, wherein the training of the shared machine learning model includes adjusting one or more weights applied by the shared machine learning model such that the shared machine learning model generates, for a first expression from the first training data, a first text representation that enables the first machine learning model to correctly determine a first intent of the first expression.

Example 3: The system of example 2, wherein the training of the shared machine learning model further includes adjusting the one or more weights applied by the shared machine learning model such that the shared machine learning model generates, for a second expression from the second training data, a second text representation that enables the second machine learning model to correctly determine a second intent of the second expression.

Example 4: The system of any one of examples 1 to 3, wherein the operations further comprise: generating a second training set to include a third training data associated with a third machine learning model performing a third text classification task; and training the shared machine learning model by at least subjecting the shared machine learning model to a first training iteration using the first training set and a second training iteration using the second training set.

Example 5: The system of any one of examples 1 to 4, wherein the operations further comprise: tuning one or more of the shared machine learning model, the first machine learning model, or the second machine learning model on the first training data and/or the second training data by applying a regularization technique.

Example 6: The system of any one of examples 1 to 5, wherein the first text classification task and the second classification task comprise natural language processing (NLP) applications associated with different industries.

Example 7: The system of any one of examples 1 to 6, wherein the shared machine learning model performs the text embedding task by applying one or more of sum, average, power mean (p-mean), word piece model, skip-thoughts-vectors, quick-thoughts-vectors, InferSent, multi-tasks learning, or Google universal sentence encoder.

Example 8: The system of any one of examples 1 to 7, wherein the shared machine learning model comprises a recurrent neural network (RNN), a convolutional neural network (CNN), and/or a transformer.

Example 9: The system of any one of examples 1 to 8, wherein the first machine learning model and/or the second machine learning model comprises one or more of a multilayer perceptron (MLP), a recurrent neural network (RNN), a convolutional neural network (CNN), or a transformer.

Example 10: The system of any one of examples 1 to 9, wherein the first machine learning model and/or the second machine learning model determines the intent of the expression by at least assigning, to the expression, one or more labels corresponding to an intent of the expression.

Example 11: A computer-implemented method, comprising: generating a first training set to include a first training data associated with a first machine learning model performing a first text classification task and a second training data associated with a second machine learning model performing a second text classification task, the first training data including a first plurality of expressions that are different than a second plurality of expressions comprising the second training data; training, based at least on the first training set, a shared machine learning model to perform a text embedding task; and deploying the trained shared machine learning model to generate a text representation of an expression that enables the first machine learning model and/or the second machine learning model to correctly determine an intent of the expression.

Example 12: The method of example 11, wherein the training of the shared machine learning model includes adjusting one or more weights applied by the shared machine learning model such that the shared machine learning model generates, for a first expression from the first training data, a first text representation that enables the first machine learning model to correctly determine a first intent of the first expression.

Example 13: The method of example 12, wherein the training of the shared machine learning model further includes adjusting the one or more weights applied by the shared machine learning model such that the shared machine learning model generates, for a second expression from the second training data, a second text representation that enables the second machine learning model to correctly determine a second intent of the second expression.

Example 14: The method of any one of examples 11 to 13, wherein the operations further comprise: generating a second training set to include a third training data associated with a third machine learning model performing a third text classification task; and training the shared machine learning model by at least subjecting the shared machine learning model to a first training iteration using the first training set and a second training iteration using the second training set.

Example 15: The method of any one of examples 11 to 14, wherein the operations further comprise: tuning one or more of the shared machine learning model, the first machine learning model, or the second machine learning model on the first training data and/or the second training data by applying a regularization technique.

Example 16: The method of any one of examples 11 to 15, wherein the first text classification task and the second classification task comprise natural language processing (NLP) applications associated with different industries.

Example 17: The method of any one of examples 11 to 16, wherein the shared machine learning model performs the text embedding task by applying one or more of sum, average, power mean (p-mean), word piece model, skip-thoughts-vectors, quick-thoughts-vectors, InferSent, multi-tasks learning, or Google universal sentence encoder.

Example 18: The method of any one of examples 11 to 17, wherein the shared machine learning model comprises a recurrent neural network (RNN), a convolutional neural network (CNN), and/or a transformer.

Example 19: The method of any one of examples 11 to 18, wherein the first machine learning model and/or the second machine learning model comprises one or more of a multilayer perceptron (MLP), a recurrent neural network (RNN), a convolutional neural network (CNN), or a transformer.

Example 20: A non-transitory computer readable medium storing instructions, which when executed by at least one data processor, result in operations comprising: generating a first training set to include a first training data associated with a first machine learning model performing a first text classification task and a second training data associated with a second machine learning model performing a second text classification task, the first training data including a first plurality of expressions that are different than a second plurality of expressions comprising the second training data; training, based at least on the first training set, a shared machine learning model to perform a text embedding task; and deploying the trained shared machine learning model to generate a text representation of an expression that enables the first machine learning model and/or the second machine learning model to correctly determine an intent of the expression.

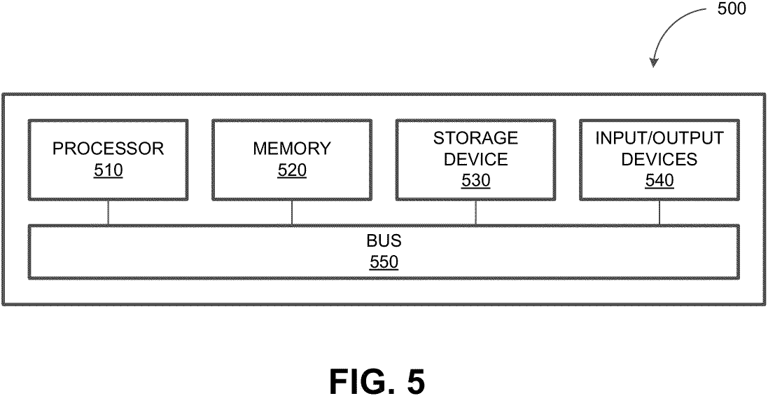

FIG. 5 depicts a block diagram illustrating a computing system 500, in accordance with some example embodiments. Referring to FIGS. 1-5, the computing system 500 can be used to implement the machine learning controller 110, the one or more natural language processing engines 120, and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the machine learning controller 110 and the one or more natural language processing engines 120. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions which, when executed by the at least one data processor, result in operations comprising:
generating a first training set to include a first training data associated with a first machine learning model performing a first text classification task and a second training data associated with a second machine learning model performing a second text classification task, the first training data including a first plurality of expressions that are different than a second plurality of expressions comprising the second training data;
training, based at least on the first training set, a shared machine learning model to perform a text embedding task; and
deploying the trained shared machine learning model to generate a text representation of an expression that enables the first machine learning model and/or the second machine learning model to correctly determine an intent of the expression.

2. The system of claim 1, wherein the training of the shared machine learning model includes adjusting one or more weights applied by the shared machine learning model such that the shared machine learning model generates, for a first expression from the first training data, a first text representation that enables the first machine learning model to correctly determine a first intent of the first expression.

3. The system of claim 2, wherein the training of the shared machine learning model further includes adjusting the one or more weights applied by the shared machine learning model such that the shared machine learning model generates, for a second expression from the second training data, a second text representation that enables the second machine learning model to correctly determine a second intent of the second expression.

4. The system of claim 1, wherein the operations further comprise:
generating a second training set to include a third training data associated with a third machine learning model performing a third text classification task; and
training the shared machine learning model by at least subjecting the shared machine learning model to a first training iteration using the first training set and a second training iteration using the second training set.

5. The system of claim 1, wherein the operations further comprise:
tuning one or more of the shared machine learning model, the first machine learning model, or the second machine learning model on the first training data and/or the second training data by applying a regularization technique.

6. The system of claim 1, wherein the first text classification task and the second classification task comprise natural language processing (NLP) applications associated with different industries.

7. The system of claim 1, wherein the shared machine learning model performs the text embedding task by applying one or more of sum, average, power mean (p-mean), word piece model, skip-thoughts-vectors, quick-thoughts-vectors, InferSent, multi-tasks learning, or Google universal sentence encoder.

8. The system of claim 1, wherein the shared machine learning model comprises a recurrent neural network (RNN), a convolutional neural network (CNN), and/or a transformer.

9. The system of claim 1, wherein the first machine learning model and/or the second machine learning model comprises one or more of a multilayer perceptron (MLP), a recurrent neural network (RNN), a convolutional neural network (CNN), or a transformer.

10. The system of claim 1, wherein the first machine learning model and/or the second machine learning model determines the intent of the expression by at least assigning, to the expression, one or more labels corresponding to an intent of the expression.

11. A computer-implemented method, comprising:
generating a first training set to include a first training data associated with a first machine learning model performing a first text classification task and a second training data associated with a second machine learning model performing a second text classification task, the first training data including a first plurality of expressions that are different than a second plurality of expressions comprising the second training data;
training, based at least on the first training set, a shared machine learning model to perform a text embedding task; and
deploying the trained shared machine learning model to generate a text representation of an expression that enables the first machine learning model and/or the second machine learning model to correctly determine an intent of the expression.

12. The method of claim 11, wherein the training of the shared machine learning model includes adjusting one or more weights applied by the shared machine learning model such that the shared machine learning model generates, for a first expression from the first training data, a first text representation that enables the first machine learning model to correctly determine a first intent of the first expression.

13. The method of claim 12, wherein the training of the shared machine learning model further includes adjusting the one or more weights applied by the shared machine learning model such that the shared machine learning model generates, for a second expression from the second training data, a second text representation that enables the second machine learning model to correctly determine a second intent of the second expression.

14. The method of claim 11, further comprising:
generating a second training set to include a third training data associated with a third machine learning model performing a third text classification task; and
training the shared machine learning model by at least subjecting the shared machine learning model to a first training iteration using the first training set and a second training iteration using the second training set.

15. The method of claim 11, further comprising:
tuning one or more of the shared machine learning model, the first machine learning model, or the second machine learning model on the first training data and/or the second training data by applying a regularization technique.

16. The method of claim 11, wherein the first text classification task and the second classification task comprise natural language processing (NLP) applications associated with different industries.

17. The method of claim 11, wherein the shared machine learning model performs the text embedding task by applying one or more of sum, average, power mean (p-mean), word piece model, skip-thoughts-vectors, quick-thoughts-vectors, InferSent, multi-tasks learning, or Google universal sentence encoder.

18. The method of claim 11, wherein the shared machine learning model comprises a recurrent neural network (RNN), a convolutional neural network (CNN), and/or a transformer.

19. The method of claim 11, wherein the first machine learning model and/or the second machine learning model comprises one or more of a multilayer perceptron (MLP), a recurrent neural network (RNN), a convolutional neural network (CNN), or a transformer.

20. A non-transitory computer readable medium storing instructions, which when executed by at least one data processor, result in operations comprising:
generating a first training set to include a first training data associated with a first machine learning model performing a first text classification task and a second training data associated with a second machine learning model performing a second text classification task, the first training data including a first plurality of expressions that are different than a second plurality of expressions comprising the second training data;
training, based at least on the first training set, a shared machine learning model to perform a text embedding task; and
deploying the trained shared machine learning model to generate a text representation of an expression that enables the first machine learning model and/or the second machine learning model to correctly determine an intent of the expression.
